(19) United States
(12) Patent Application Publication
(10) Pub. No.: US 2005/0017632 A1
(43) Pub. Date: Jan. 27, 2005

(54) Organic buffer layer for organic light-emitting device and producing method thereof

(76) Inventors: Xiao-Yuan Hou, Shanghai (CN); Yi-Qiang Zhan, Shanghai (CN)

Correspondence Address: Raymond Y. Chan, Suite 128, 108 N. Ynez Ave., Monterey Park, CA, 91754, US

(21) Appl. No.: 10/810,447

(22) Filed: Mar. 26, 2004

(30) Foreign Application Priority Data
Jul. 24, 2003 (CN) 03141803.1

(51) Int. Cl. H01J 1/62

(52) U.S. Cl. 313/506

(57) ABSTRACT

An organic light-emitting device includes an anode glass base, a hole transporting layer, an organic light-emitting layer, an electron transporting layer, and a metallic cathode layer overlapped with each other. An organic buffer layer, which is overlappedly disposed between the electron transporting layer and the metallic cathode layer, has a hydrophilic head group firmly bonding with the metallic cathode layer and a lipophilic tail group firmly bonding with the electron transporting layer such that the organic buffer layer forms as a heat insulating media between the organic light-emitting layer and the metallic cathode layer for preventing an uneven thermal expansion difference therebetween during operating the organic light-emitting device.

### BACKGROUND OF THE PRESENT INVENTION

1. Field of Invention

The present invention relates to an organic light-emitting device (OLED), and more particularly to an organic buffer layer for an organic light-emitting device, which comprises a thin organic buffer layer inserted between an organic light-emitting layer and a metallic cathode layer of the light-emitting device, so as to enhance the stability of the organic light-emitting device and increase electron injection thereof.

2. Description of Related Arts

In 1987, E. Kodak Co. has been produced 8-hydroxyquinoline aluminum for an organic electroluminescent device (OLED), which is an even and compact high quality thin film made of organic small molecule material, having a high luminescent efficiency, by vacuum deposition. This made the research in the field enter a whole new epoch. Over more than a decade, people had made great improvement in enhancing the manufacturing workmanship of OLED and in understanding the physical principals that affects the performance of the control devices. All performance indices of OLED have satisfied the requirements for large-scaled application, which heralds the coming of industrial production.

The outstanding properties of OLED include high efficiency, high brightness, self-luminousness, wide viewing angle, full color, high contrast ratio, high resolution, no background lighting, no filter and polarizing filter, low power consumption, low operating voltage, direct current driving, fast response speed, thin and light in weight, strong in structure, foldable when applied on a soft substrate, being easily to obtain complex images simply by ink jet, inexpensive producing line and equipment, being readily integrated to other products, and excellent performance to price ratio.

However, the organic electroluminescent technology still has some issues that are not completely solved up until now. One of such issues is the instability of OLED caused by the discrepancy of chemical and physical properties, such as thermal expansion coefficient and interphilics, between the organic layer and the inorganic metallic cathode. The problem has become a bottleneck of the commercialization of organic light-emitting technology in some degree.

### SUMMARY OF THE PRESENT INVENTION

A main object of the present invention is to provide an amphiphilic buffer layer for an organic light-emitting device (OLED), which comprises a thin organic buffer layer inserted between an organic layer and a metallic cathode layer of the light-emitting device, so as to enhance the stability of the organic light-emitting device and increase electron injection thereof.

Accordingly in order to accomplish the above object, the present invention provides an organic light-emitting device, comprising:
an anode glass base;
a hole transporting layer overlapped on the anode glass base;
an organic light-emitting layer overlapped on the hole transporting layer such that the hole transporting layer is sandwiched between the anode glass base and the organic light-emitting layer;
an electron transporting layer overlapped on the organic light-emitting layer;
a metallic cathode layer overlapped on the electron transporting layer; and
an organic buffer layer, which is overlappedly disposed between the electron transporting layer and the metallic cathode layer, having a hydrophilic head group firmly bonding with the metallic cathode layer and a lipophilic tail group firmly bonding with the electron transporting layer such that the organic buffer layer forms as a heat insulating media between the organic light-emitting layer and the metallic cathode layer for preventing an uneven thermal expansion difference therebetween during operating the organic light-emitting device.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of an organic light-emitting device according to a preferred embodiment of the present invention.

FIG. 2 is a chart illustrating the performances of a NaSt buffer layer of the organic light-emitting device before and after a thermal process according to the above preferred embodiment of the present invention.

FIG. 3 is a chart illustrating the performances of a LiF buffer layer of a conventional organic light-emitting device before and after a thermal process.

### DETAILED DESCRIPTION OF THE PREFERRED EMBODIMENT

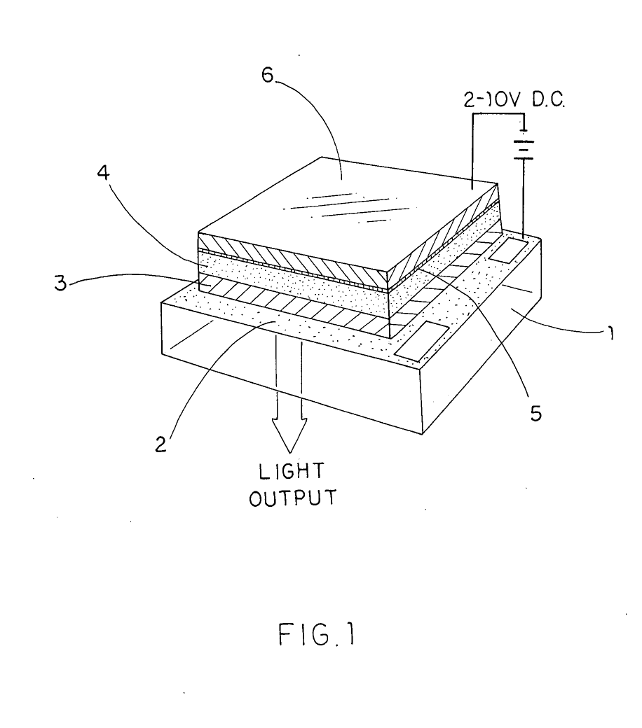

Referring to FIG. 1 of the drawings, an organic light-emitting device according to a preferred embodiment of the present invention is illustrated, wherein the organic light-emitting device comprises an anode glass base 1, a hole transporting layer 2 overlapped on the anode glass base 1, and an organic light-emitting layer 3 overlapped on the hole transporting layer 2 such that the hole transporting layer 3 is sandwiched between the anode glass base 1 and the organic light-emitting layer 3.

The organic light-emitting device further comprises an electron transporting layer 4 overlapped on the organic light-emitting layer 3, a metallic cathode layer 6 overlapped on the electron transporting layer 4, and an organic buffer layer 5 overlappedly disposed between the electron transporting layer 4 and the metallic cathode layer 6. The organic buffer layer 5 is made of amphiphilic having a hydrophilic head group firmly bonding with the metallic cathode layer 6 and a lipophilic tail group firmly bonding with the electron transporting layer 4 such that the organic buffer layer 5 forms as a heat insulating media between the electronic transporting layer 4 and the metallic cathode layer 6 for preventing an uneven thermal expansion difference therebetween during operating the organic light-emitting device.

According to the preferred embodiment, the organic light-emitting device is embodied as an organic electroluminescent device (OLED). The hole transporting layer 2 is embodied as the NPB. The organic light-emitting layer 3 and the electron transporting layer 4 are made of 8-hydroxyquinoline aluminum (Alq₃). The metallic cathode layer 6 is made of aluminum (Al).

The organic buffer layer 5 is made of amphiphilic molecule material as a substitution of the conventional inorganic salts such as LiF for the organic light-emitting device. The organic buffer layer 5 has a thickness from 2 to 4 nanometers. Accordingly, the fatty acid salt of the organic buffer layer has a chemical structure containing five to twenty carbon atoms (C₅ to C₂₀), wherein the head group of the fatty acid salt is formed as hydrophilic and the tail group of the fatty acid salt is formed as lipophilic. It is worth to mention that the head group of the fatty acid salt has a strong hydrophilic carboxyl and metallic ion to firmly bond with the metallic cathode layer 6. In addition, the amphiphilic molecular buffer layer 6 is cultivated by vacuum deposition to obtain a better ordering. The fatty acid salt comprises sodium stearate (NaSt), zinc stearate (ZnSt), aluminum stearate (AlSt), sodium oleate (NaOl), or sodium zincate (NaZt).

When the organic light-emitting device is switched on to emit light, a current passing though the organic light-emitting device will produce Joule heat, which will raise a temperature of the organic light-emitting device. Thermal expansion occurs in both the metallic cathode layer 6 and the organic layer 3. A discrepancy in thermal expansion coefficients of the metallic cathode layer 6 and the organic layer 3 will inevitably cause curliness and delamination of the organic layer 3 and thus destroy the layer structure of the organic light-emitting device. When the organic buffer layer 5 is disposed between the electron transporting layer 4 and metallic cathode layer 6, an elastic structure of the organic buffer layer 5 will provides a better capability to withdraw thermal attack, so as to increase a thermal stability of the organic light-emitting device. At the same time, the organic buffer layer 5 is also able to increase electron injection as the conventional buffer layers.

A thermal vaporization system can be used to produce the organic buffer layer 5 of the invention. A vacuum degree of the thermal vaporization system should be above 1.0*10⁻³ Pascal, and a temperature thereof should be between 300° C. and 400° C. At a grow rate from 0.1 to 0.9 nanometer per minute, the organic buffer layer 5 is produced to control the growth of the organic buffer layer 5 and the thickness thereof.

In a preferred embodiment of the invention, a high vacuum system of organic molecule beam deposition (OMBD) is used to produce the organic buffer layer 5. The system is operated under a vacuum pressure of 1*10⁻⁶ Pascal and 13 beam ovens in which a whole process of growing will complete. It is worth to mention that nearly all thermal deposition systems can be used to produce the organic buffer layer 5.

Accordingly, sodium stearate (NaSt) is selected as the material to produce the organic buffer layer 5. Temperature of the oven is controlled at 340° C.±1° C., which ensures a growth rate of the organic buffer layer 5 from 0.3 to 0.5 nanometer per minute.

With such a low growth rate, the NaSt molecule has enough time to select a low energy direction wherein the lipophilic tail thereof is arranged to contact with the electron transporting layer 4 (Alq₃) while the hydrophilic head thereof is arranged to contact with metallic cathode layer 6 (aluminum). An observation in assistance of atomic force microscopy proved the organic buffer layer 5 of NaSt produced under such condition is very even and smooth.

Alternatively, through the thermal deposition system, ZnSt, AlSt, and NaOl can be selected as the material to form the organic buffer layer 5 having a thickness of approximately 2, 3, and 4 nanometers at the temperature of 300° C., 350° C., and 400° C. respectively. Thus, the organic buffer layer 5 made of such materials has the stability as the organic buffer layer 5 produced in above preferred embodiment.

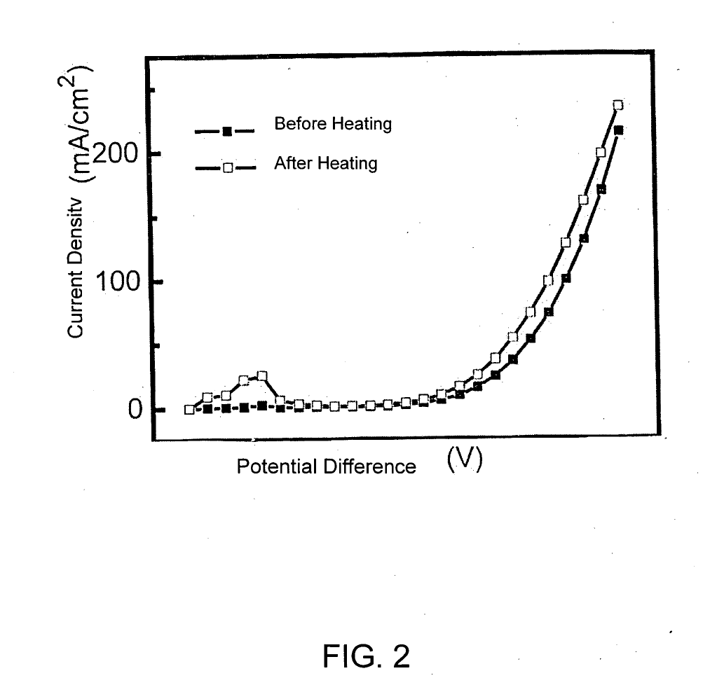

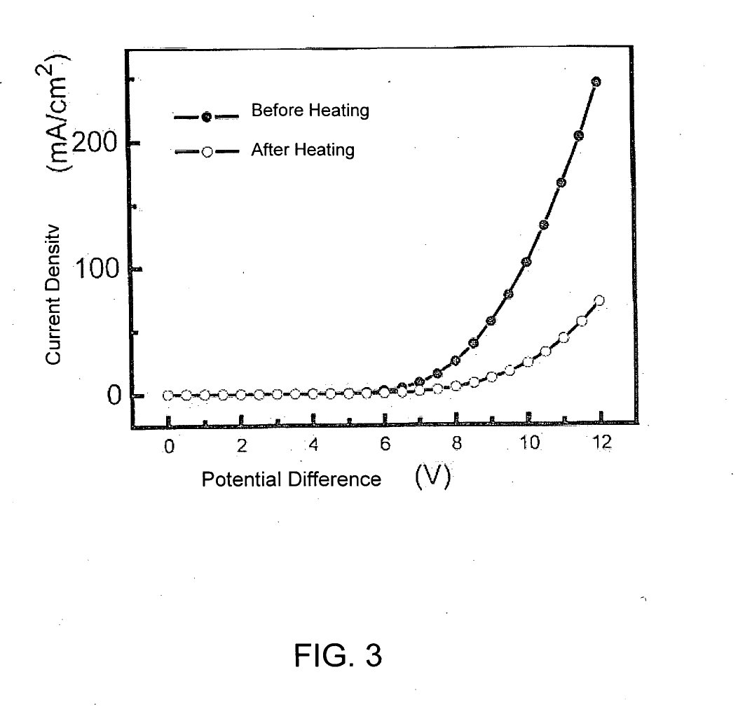

In order to measure the performance of the organic light-emitting, heat is applied on the organic light-emitting device under a predetermined condition. The organic light-emitting device is heated up at 80° C. for one hour and is then cooled then to a room temperature. Accordingly, there is a 70% efficiency loss of the conventional OLED after heat treatment in comparison with the conventional OLED before heat treatment, as shown in FIG. 3. However, the efficiency loss of the organic light-emitting device after heat treatment is minimized in comparison with the organic light-emitting device before heat treatment when using the organic buffer layer 5, as shown in FIG. 2.

In view of above, the organic buffer layer 5 is easily produced to incorporate with the organic light-emitting device to effectively enhance the stability and electron injection of the organic light-emitting device during operation.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1. An organic light-emitting device, comprising:
an anode glass base;
a hole transporting layer overlapped on said anode glass base;
an organic light-emitting layer overlapped on said hole transporting layer such that said hole transporting layer is sandwiched between said anode glass base and said organic light-emitting layer;
an electron transporting layer overlapped on said organic light-emitting layer;
a metallic cathode layer overlapped on said electron transporting layer; and
an organic buffer layer, which is overlappedly disposed between said electron transporting layer and said metallic cathode layer, having a hydrophilic head group firmly bonding with said metallic cathode layer and a lipophilic tail group firmly bonding with said electron transporting layer such that said organic buffer layer forms as a heat insulating media between said organic light-emitting layer and said metallic cathode layer for preventing an uneven thermal expansion difference therebetween during operating said organic light-emitting device.

2. An organic light-emitting device, as recited in claim 1, wherein said organic buffer layer is made of fatty acid salt having a chemical structure containing five to twenty carbon atoms (C₅ to C₂₀), wherein said head group of said fatty acid salt is formed as hydrophilic and said tail group of said fatty acid salt is formed as lipophilic.

3. An organic light-emitting device, as recited in claim 1, wherein said organic buffer layer has a thickness from 2 to 4 nanometers.

4. An organic light-emitting device, as recited in claim 2, wherein said organic buffer layer has a thickness from 2 to 4 nanometers.

5. An organic light-emitting device, as recited in claim 2, wherein said fatty acid salt is composed of sodium stearate (NaSt).

6. An organic light-emitting device, as recited in claim 4, wherein said fatty acid salt is composed of sodium stearate (NaSt).

7. An organic light-emitting device, as recited in claim 2, wherein said fatty acid salt is composed of zinc stearate (ZnSt).

8. An organic light-emitting device, as recited in claim 4, wherein said fatty acid salt is composed of zinc stearate (ZnSt).

9. An organic light-emitting device, as recited in claim 2, wherein said fatty acid salt is composed of aluminum stearate (AlSt).

10. An organic light-emitting device, as recited in claim 4, wherein said fatty acid salt is composed of aluminum stearate (AlSt).

11. An organic light-emitting device, as recited in claim 2, wherein said fatty acid salt is composed of sodium oleate (NaOl).

12. An organic light-emitting device, as recited in claim 4, wherein said fatty acid salt is composed of sodium oleate (NaOl).

13. An organic light-emitting device, as recited in claim 2, wherein said fatty acid salt is composed of sodium zincate (NaZt).

14. An organic light-emitting device, as recited in claim 4, wherein said fatty acid salt is composed of sodium zincate (NaZt).

15. A method of producing an organic buffer layer for an organic light-emitting device, comprising the steps of:
(a) providing a fatty acid salt having a chemical structure containing five to twenty carbon atoms (C₅ to C₂₀); and
(b) growing said fatty acid salt through a thermal deposition system having a vacuum degree above 1.0*10⁻³ Pascal, and a temperature between 300° C. and 400° C., to control a growing speed of said fatty acid from 0.1 to 0.9 nanometer per minute so as to produce said organic buffer layer.

16. The method, as recited in claim 15, wherein said fatty acid salt has a head group of formed as hydrophilic and a tail group formed as lipophilic.

17. The method, as recited in claim 16, wherein said fatty acid salt is composed of sodium stearate (NaSt) to form said organic buffer layer has a thickness from 2 to 4 nanometers.

18. The method, as recited in claim 16, wherein said fatty acid salt is composed of zinc stearate (ZnSt) to form said organic buffer layer has a thickness approximately 2 nanometers.

19. The method, as recited in claim 16, wherein said fatty acid salt is composed of aluminum stearate (AlSt) to form said organic buffer layer has a thickness approximately 3 nanometers.

20. The method, as recited in claim 16, wherein said fatty acid salt is composed of sodium oleate (NaOl) to form said organic buffer layer has a thickness approximately 4 nanometers.
